(19) United States
(12) Patent Application Publication
(10) Pub. No.: US 2026/0033495 A1
(43) Pub. Date: Feb. 5, 2026

(54) CRYSTAL FORMS OF SULFOXAFLOR

(71) Applicant: ADAMA MAKHTESHIM LTD., Beer Sheva (IL)

(72) Inventors: Judith Aronhime, Rehovot (IL); Robert Dinnebier, Stuttgart (DE); Marijana Pavisic, Zagreb (HR); Michael Grabarnick, Metar (IL)

(21) Appl. No.: 19/262,190

(22) Filed: Jul. 8, 2025

Related U.S. Application Data
(60) Provisional application No. 63/668,446, filed on Jul. 8, 2024.

(51) Int. Cl. A01N 47/40; A01P 7/04

(52) U.S. Cl. CPC A01N 47/40; A01P 7/04

(57) ABSTRACT

A composition of stereoisomers of sulfoxaflor, where these stereoisomers are selected from diastereomers A and B at a selected A:B ratio, are provided as a mixture of crystal structures, and are water soluble with water solubility of at least about 0.7±0.07 mg/ml, methods for preparing them and insecticides and/or pesticides preparations comprising them.

### TECHNICAL FIELD

The present invention pertains to sulfoximine, specifically to sulfoxaflor with the chemical name of {1-[6-(trifluoromethyl)pyridine-3-yl] ethyl}(methyl)oxido-λ⁴-sulfanylidenecyanamide. More particularly, the present invention pertains to polymorphs in combinations of stereoisomers of sulfoxaflor at different ratios that form certain crystal structures, where such combinations are advantageously more water soluble than current combinations, methods for preparing such combinations, and formulations/compositions comprising them for use as pesticides and more specifically insecticides.

### BACKGROUND

Sulfoxaflor is described in U.S. Pat. No. 9,125,412 as a mixture of diastereomers A and B.

Diastereomers A is a racemic mixture of enantiomers {(R)-1-[6-(triflouromethyl)pyridin-3-yl] ethyl}-(R)-(methyl)oxido-λ⁴-sulfanylidenecyanamide and {(S)-1-[6-(triflouromethyl)pyridin-3-yl]ethyl}-(S)-(methyl)oxido-λ⁴-sulfanylidenecyanamide, while diastereomers B is a racemic mixture of enantiomers {(R)-1-[6-(triflouromethyl)pyridin-3-yl]ethyl}-(S)-(methyl)oxido-λ⁴-sulfanylidenecyanamide and {(S)-1-[6-(triflouromethyl)pyridin-3-yl]ethyl}-(R)-(methyl)oxido-λ⁴-sulfanylidenecyanamide.

U.S. Pat. No. 9,125,412 mentions that the crude product purified by chromatography (chromatotron, 70 percent acetone/CH₂Cl₂) furnishes the sulfoximine (specifically sulfoxaflor) as a 2:1 mixture of diastereomers. The material is described as a colorless oil.

U.S. Pat. No. 9,125,412 also mentions that sulfoxaflor with an approximate 1:2 ratio between diastereomer groups A and B have been suspended in water with additional materials, but without disclosing how the 1:2 ratio material have been prepared and what are its physical properties. U.S. Pat. No. 9,125,412 also describes the A:B mixture with a ratio of 3:1 and above as advantageously more stable and preferred for formulations. In fact, U.S. Pat. No. 9,125,412 aims at prolonging the shelf-life of compositions of sulfoxaflor with a particular ratio of its diastereomers because of the naturally occurring conversion of diastereomers B to diastereomers A with time.

In addition, U.S. Pat. No. 9,125,412 describes the isolation of an A:B mixture with an approximate mixture ratio of 1:2 and conversion in the formulation medium to a high percent of diastereomers A by keeping the formulation together with other ingredients at elevated temperatures for up to 100 hrs.

Three crystal structures of sulfoxaflor are published in the literature and detailed below:
a) Crystal structure of (2R,3R)-sulfoxaflor deposited in the CCDC database as 2088797, published in Science of The Total Environment, Volume 817, 15 Apr. 2022, 153007. This structure is entitled in the present application as “crystal form 1a” with the following crystal properties: (P 2₁ 2₁ 2₁ (19), Cell: a 5.6473(5) Å b 11.2910(12) Å c 18.605(2) Å, α 90° β 90° γ 90°).
b) Crystal structure of (2S,3R)-sulfoxaflor published and deposited in the CCDC database as 2088798, and also published in Science of The Total Environment, Volume 817, 15 Apr. 2022, 153007. This structure is entitled in the present application as “crystal form 3b” with the following crystal properties: (P 2₁ (4), Cell: a 5.8177(8) Å b 35.042(5) Å c 12.5571(17) Å, α 90° β 98.006(6)° γ 90°).
c) Crystal structure of (2R,3S)-sulfoxaflor published in Z. Kristallogr. NCS 2020; 235(4): 861-862 (CCDC no.: 1986677). This structure is entitled in the present application as “form 1b” with the following crystal properties: (P 2₁/c (14), Cell: a 18.555(10) Å b 6.785(4) Å c 10.139(5) Å, α 90° β 105.86° γ 90°).

XRPD patterns and DSC thermograms of crystal form 1a and crystal form 1b isolated in the present invention are shown in FIGS. 1, 2, 3 and 4. FIGS. 11-13 show the calculated XRPD patterns of the isolated isomers of sulfoxaflor.

In particular, FIG. 11 shows the XRPD pattern of the (2R,3R) isomer of sulfoxaflor calculated from the data deposited in the CCDC database as 2088797. This structure is denominated in the present application as “crystal form 1a”.

FIG. 12 shows the XRPD pattern of the (2S,3R) isomer of sulfoxaflor calculated from the data deposited in the CCDC database as 2088798. This structure is denominated in the present application as “crystal form 3b”.

FIG. 13 shows the XRPD pattern of the (2R,3S) isomer of sulfoxaflor calculated from the data in CCDC no.: 1986677. This structure is denominated in the present application as “crystal form 1b”.

The sulfoxaflor, which is synthesized in the present invention, is a mixture of diastereomers. The DSC thermogram of Sulfoxaflor isolated in the present invention as crystal form 1a shows a melting peak with peak maximum temperature at about 154-159° C. The DSC thermogram of Sulfoxaflor isolated in the present invention as crystal form 1b shows a melting peak with peak temperature maximum at about 125° C.

Although the 3:1 A:B ratio and above was described as advantageous for stability in formulation, it has been surprisingly found that a 3:7 A:B ratio of sulfoxaflor is advantageous from the solubility point of view and can be used both for dry and wet formulations.

It is, therefore, an object of the present invention to provide mixtures of stereoisomers of sulfoxaflor in varying ratios that crystallize in crystal forms, which are more water soluble than currently known formulations of sulfoxaflor.

It is yet another object of the present invention to provide methods for preparing mixtures of stereoisomers of sulfoxaflor at varying ratios that crystallize in crystal forms, which are more water soluble than currently known formulations of sulfoxaflor.

It is yet another object of the present invention to provide an insecticide formulations and compositions that comprise mixtures of stereoisomers of sulfoxaflor at varying ratios that crystalize in polymorphic combinations, which are more water soluble than currently known forms of sulfoxaflor.

This and other objects and embodiments of the present invention shall become apparent as the description proceeds.

### SUMMARY

In one aspect, the present invention pertains to mixtures of stereoisomers of sulfoxaflor that crystallize in varying polymorphic combinations, particularly in a ratio of isomers that makes such mixtures advantageously more water soluble than currently known mixtures of sulfoxaflor stereoisomers.

In still another aspect, the present invention pertains to methods for preparing mixed crystals comprising stereoisomers of sulfoxaflor that crystalize in varying polymorphs and diasteromer combinations, where that ratio between the isomers renders such mixtures advantageously more water soluble than currently known mixtures of sulfoxaflor stereoisomers.

In one embodiment, the present invention provides a mixture of stereoisomers of sulfoxaflor with prevalent diastereomers A content (about 90-96%), crystallized in mixed crystal form (form Y), which includes the known crystal form 1a and new crystal phase. The new crystal phase always crystallizes with crystal form 1a in the same ratio producing a constant XRPD pattern. Form Y has a higher solubility than the known crystal form 1a.

This new crystal phase is entitled Yn and may be characterized by the following X-Ray diffraction peaks:
15.5, 16.3, 17.4, 19.4, 21.3, 22.7±0.2 deg 2theta.

Further, crystal form Yn has the following crystal structure parameters:

| Space group | P21/c |
|---|---|
| Cell Volume | 1191.50 |
| (Å\hat{ }3) | |
| a (Å) | 5.697 |
| b (Å) | 11.405 |
| c (Å) | 18.365 |
| beta (°) | 93.10 |

FIG. 14 shows the calculated XRPD pattern of crystal form Yn. The crystal structure parameters were extracted and calculated from the XRPD of crystal Y, which is a mixture of crystal form Yn and the known crystal form 1a. Table I below details further the XRPD peaks of form Y sorted to its components, crystal form 1a and the new crystal phase Yn.

TABLE I
XRPD peaks of crystal form Y

| | new phase - | |
|---|---|---|
| 1a | Yn | Y |
| 9.2 | 9.2 | 9.2 |
| 9.6 | 9.7 | 9.7 |
| 12.4 | 12.3 | 12.4 |
| | 15.5 | 15.5 |
| 16.4 | 16.3 | 16.3 |
| | 17.4 | 17.4 |
| | 17.8 | 17.9 |
| 18.2 | | shoulder |
| 18.4 | 18.3 | 18.3 |
| | 18.7 | 18.8 |
| 19.1 | | 19.2 |
| | 19.4 | 19.4 |
| 20.0 | | 20.0 |
| | 20.3 | 20.3 |
| 20.7 | | |
| 21.3 | 21.3 | 21.3 |
| 22.2 | 22.2 | 22.1 |
| 22.8 | 22.7 | 22.7 |
| 24.32 | 24.4 | 24.4 |
| 24.8 | | 24.8 |
| 25.6 | 25.5 | 25.5 |
| 26.1 | | 26.0 |
| 26.6 | | 26.5 |
| | 26.7 | 26.7 |
| 27.7 | 27.6 | 27.7 |
| | 28.5 | 28.5 |
| 28.8 | 29.0 | 28.9 |
| 29.5 | 29.3 | 29.3 |
| 29.8 | 29.6 | 29.8 |
| 30.1 | 30.0 | 30.0 |

In still another embodiment, the present invention provides a mixed crystal form X that comprises stereoisomers of sulfoxaflor, comprising a diastereomers ratio A:B between 3:7 and 2:8, which shows a DSC thermogram with one melting peak having a peak temperature maximum at about 114-119° C. Sulfoxaflor crystal form X has a high water solubility.

In still another embodiment, the present invention provides a stereoisomer mixture with enhanced purity of diastereomers A of 90%, preferably 94%, more preferably 98% and even more preferably 99%±1% in a crystallized state.

In still another embodiment, the present invention provides straight-forward crystallization procedures to isolate stereoisomer mixture with enhanced purity of diastereomers A of 90%, preferably 94%, more preferably 98% and even more preferably 99%±1%. Particularly, such procedures avoid preparation of a complex formulation combined with storage at elevated temperature for a long period of time as is described in table 3 in U.S. Pat. No. 9,125,412.

In still another embodiment, the present invention provides straight-forward crystallization procedures for producing crystal forms X, Y and pure diastereomers A, which are advantageously more water soluble than currently known formulations of crystalline sulfoxaflor. In particular, the present invention provides a method for preparing crystal forms Y, X and pure diastereomers A of sulfoxaflor, where such method is selected from crash-cooling, solvent-anti-solvent, mother liquor evaporation and crystallization during filtration methods for crystallizing these forms of sulfoxaflor.

In still another particular embodiment, the crash-cooling method comprises:
dissolving a starting material of sulfoxaflor in a solvent;
heating and stirring a solution of the sulfoxaflor;
rapidly cooling the solution in an ice bath with a temperature between 0 and 5° C.;
letting forms, Y or pure diastereomers A make a suspension; and
optionally isolating a solid material from the suspension.

In still another particular embodiment, the mother liquor evaporation method is for preparing form X that comprises a combination of diastereomers A and B, where solvent/anti-solvent pairs or a single solvent are used. Crystal form X is crystallized from the mother liquor from which the main phase is crystallized and separated. In particular, the solvent/anti-solvent pairs are selected from dichloromethane/heptane and ethanol 96%/water and the single solvents used are selected from t-butyl methyl ether, dichloroethane and i-propyl acetate.

The method of producing crystal form X comprises:
Crystallizing the main phase and separating it from the mother liquor;
evaporating the mother liquor and crystallizing a new solid material in a suspension; and
optionally isolating the new solid material from the suspension.

In particular, producing the mother liquor for producing form X comprises:
dissolving a starting material of sulfoxaflor in a solvent;
heating and stirring a solution of the sulfoxaflor;
cooling the solution;
drop-wisely adding an anti-solvent to the solution after cooling, where this anti-solvent is cooled in an ice bath;
stirring the anti-solvent to the solution until a suspension is formed; and
disposing the solid material from the suspension.

In still another particular embodiment isolating or disposing the solid material is selected from filtering, sedimentation and decantation, evaporation and centrifugation.

In still another particular embodiment, the solvent-anti-solvent method comprises:
dissolving a starting material of sulfoxaflor in a solvent;
heating and stirring a solution of the sulfoxaflor;
cooling the solution;
drop-wisely adding an anti-solvent to the solution after cooling, where this anti-solvent is cooled in an ice bath; and
stirring the anti-solvent to the solution until crystallization of the solid material.

In still another particular embodiment, the solvent-anti-solvent method further comprises isolating the crystal form from the suspension, where isolating is selected from filtering the crystal form, sedimentation and decantation, evaporation and centrifugation.

Insecticide and/or pesticide preparations, compositions and formulations that comprise these crystal forms selected from X, Y and pure diastereomers A alone or in addition to other insecticide and pesticide compounds are also contemplated within the scope of the present invention.

In still another embodiment, the present invention provides a method for producing a novel crystal phase of sulfoxaflor and the novel crystal phase, which is produced in this method. Particularly, this novel crystal phase is produced with a mixture of crystal structure 1a of sulfoxaflor, and provides it advantageously higher water solubility than currently known crystal structures, mixtures of crystal structures and ratios thereof of sulfoxaflor.

The following details particular non-limiting examples and embodiments of the present invention without departing from the scope and spirit of the present invention.

### BRIEF DESCRIPTION OF THE DRAWINGS

FIG. 1 shows an XRPD pattern of crystal form 1a of sulfoxaflor

FIG. 2 shows a DSC thermogram of crystal form 1a of sulfoxaflor.

FIG. 3 shows an XRPD pattern of crystal form 1b of sulfoxaflor.

FIG. 4 shows a DSC thermogram of crystal form 1b of sulfoxaflor.

FIG. 5 shows an XRPD pattern of crystal form Y of sulfoxaflor.

FIG. 6 shows an XRPD comparison between crystal form Y and crystal form 1a of sulfoxaflor.

FIG. 7 shows a DSC thermogram of crystal form Y of sulfoxaflor.

FIG. 8 shows a DSC thermogram of crystal form X of sulfoxaflor.

FIG. 9 shows an XRPD pattern of f crystal form X of sulfoxaflor.

FIG. 10 shows an XRPD pattern of sulfoxaflor starting material.

FIG. 11 shows the calculated XRPD pattern of the crystal structure of (2R,3R)-sulfoxaflor 2088797.

FIG. 12 shows the calculated XRPD pattern of the crystal structure of (2S,3R)-sulfoxaflor 2088798.

FIG. 13 shows the calculated XRPD pattern of the crystal structure of (2R,3S)-sulfoxaflor 1986677.

FIG. 14 shows the calculated XRPD pattern of the new crystal phase Yn.

### DETAILED DESCRIPTION OF THE DRAWINGS

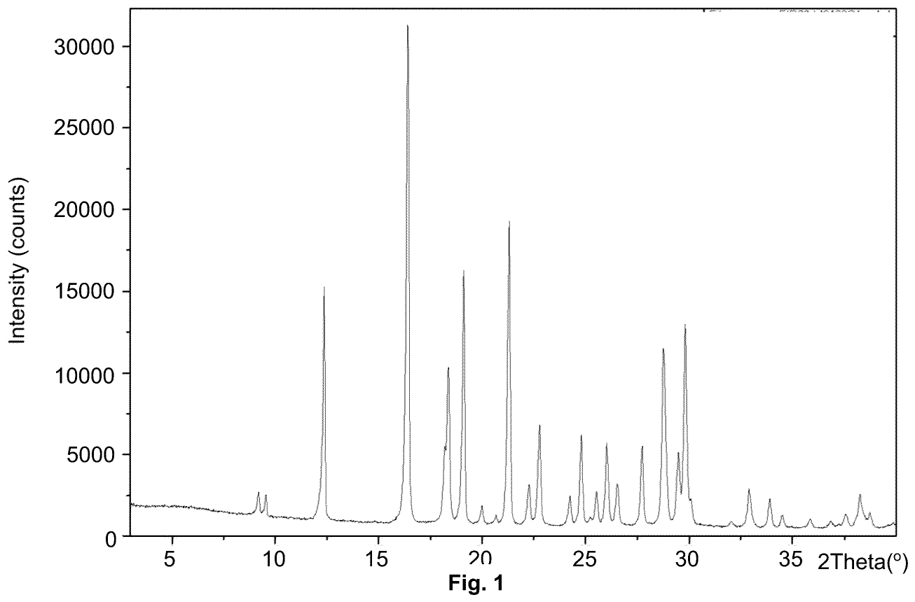

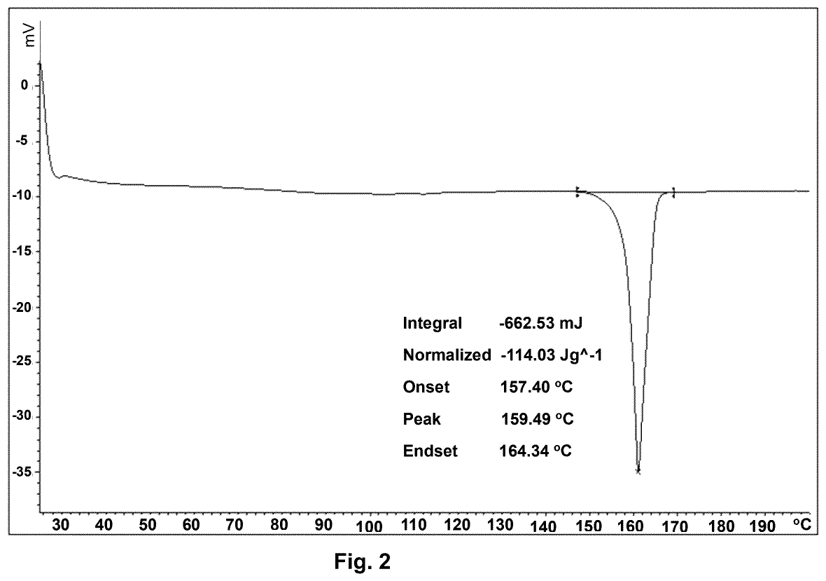

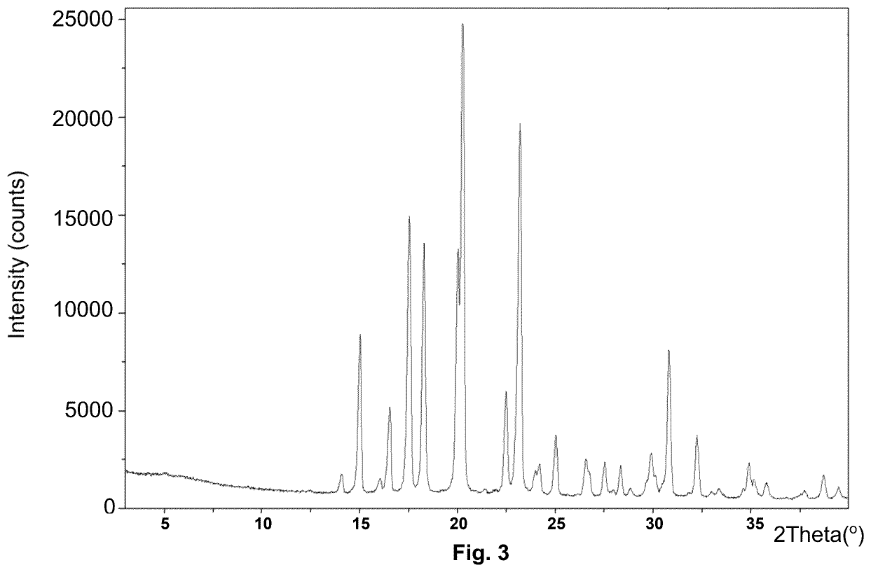

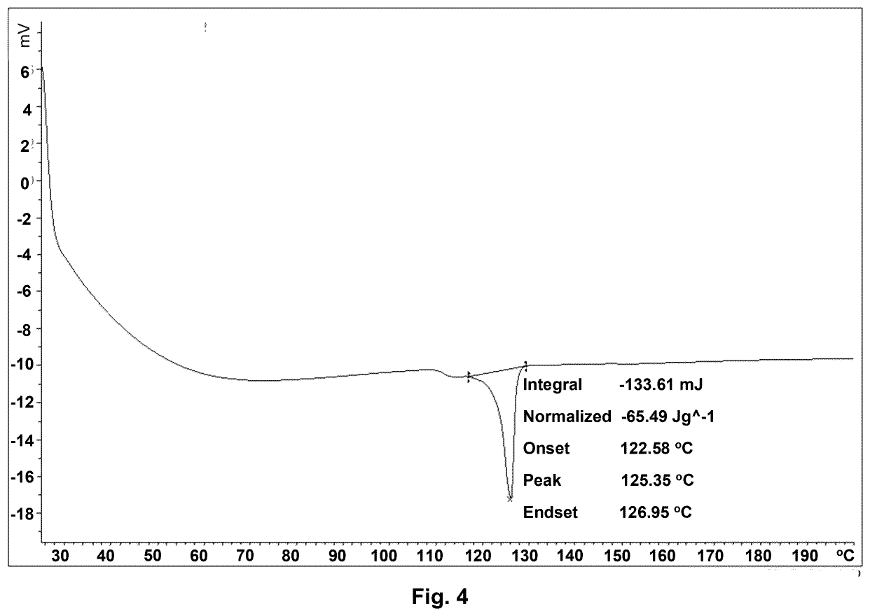

FIGS. 1-10 show x-ray diffraction patterns and thermal diagrams which are characteristic of the different crystal forms of sulfoxaflor, which have been prepared in the present invention. As mentioned above, three particular mixtures of stereoisomers in crystal form with particular interest in their water solubility have been produced, namely crystal forms X, Y and pure diastereomers A. Their X-ray diffraction patterns and thermal characteristics are shown in particular in FIGS. 1-2 and 5-9 and their numerical values are detailed below.

### Crystal Form Y

Novel crystal form Y (which is a racemic mixture of R,R and S,S isomers), is characterized primarily by characteristic XRPD peaks at 15.5, 16.3, 17.4, 19.2, 26.0±0.2 deg 2-theta, and further peaks at 19.4, 20.0, 21.3, 22.7±0.2 deg 2-theta.

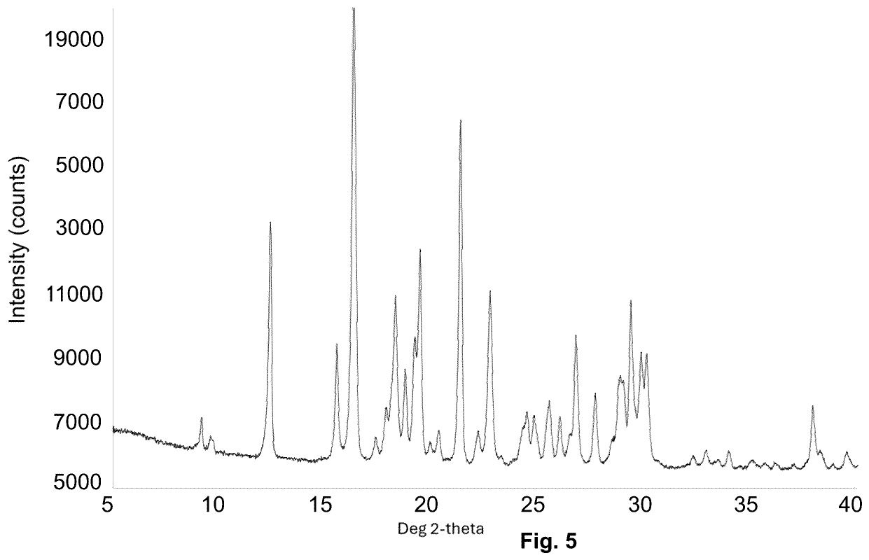

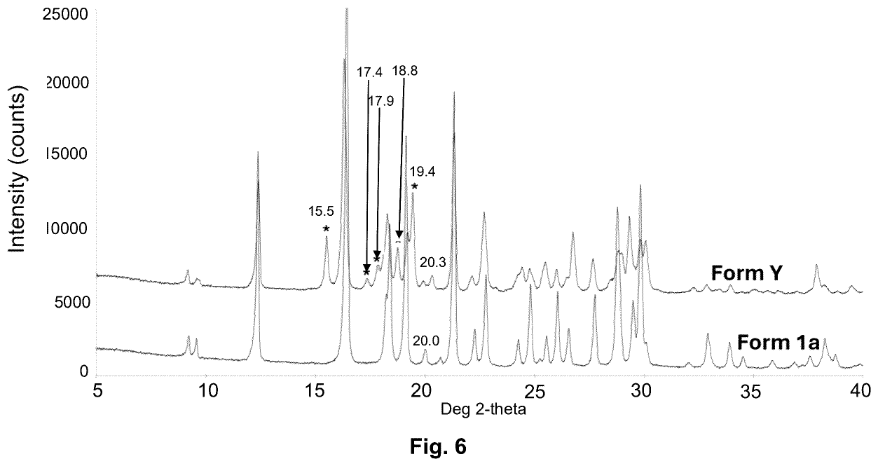

Novel crystal form Y is characterized also by an XRPD pattern as shown in FIG. 5. See also the comparison in FIG. 6 between X-ray diffraction patterns of crystal forms 1a and Y of sulfoxaflor.

Crystal form Y is characterized by having a diastereomers ratio A:B of about 90% content of the racemic mixture of diastereomers A, preferably 92%, more preferably 94% and more preferably 96%±1% of the total content of crystal form Y.

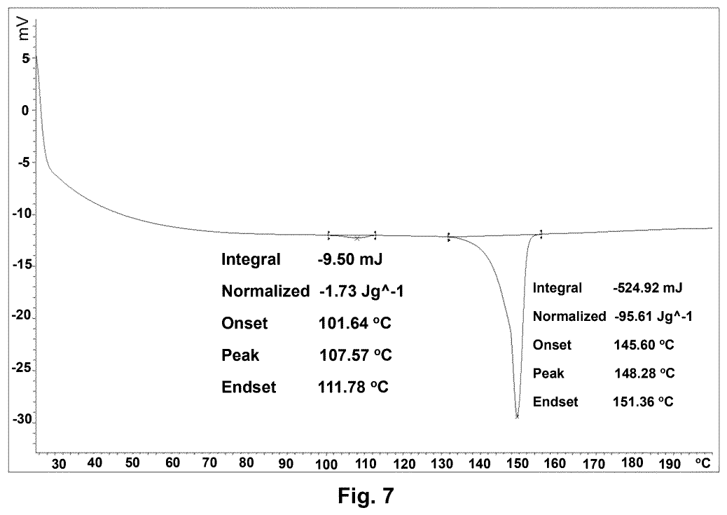

Crystal form Y displays a DSC thermogram with a broad melting peak having a peak maximum temperature in the range of 140-160° C. A very small endotherm within the range of 100-115° C. deg is sometimes detected, as shown in FIG. 7.

Crystal form Y has solubility in water of about 1.2±0.3 mg/ml, vs. solubility of crystal form 1a of about 0.7±0.07 mg/ml.

In one particular embodiment, the ratio A:B of diastereomers A and B in crystal form 1a with a solubility of 0.7±0.07 mg/ml is 97:3.

### Crystal Form X

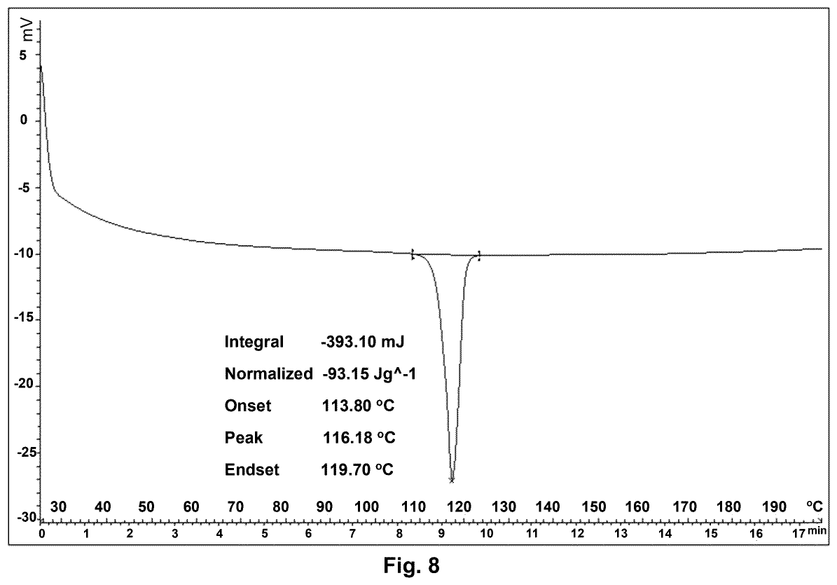

Sulfoxaflor in the crystal form X with diastereomers B content, which is a racemic mixture of R,S and S,R isomers, between about 60% and 80%, preferably between 65% and 75% and more preferably at 70% crystal, displays a DSC thermogram having a melting peak with peak maximum temperature ranging between about 114-119° C. This melting peak maximum temperature is lower than that of the known crystal forms 1a and 1b. See FIG. 8.

Crystal form X has solubility in water of about 1.6±0.3 mg/ml, vs solubility of crystal form 1a of about 0.7±0.07 mg/ml.

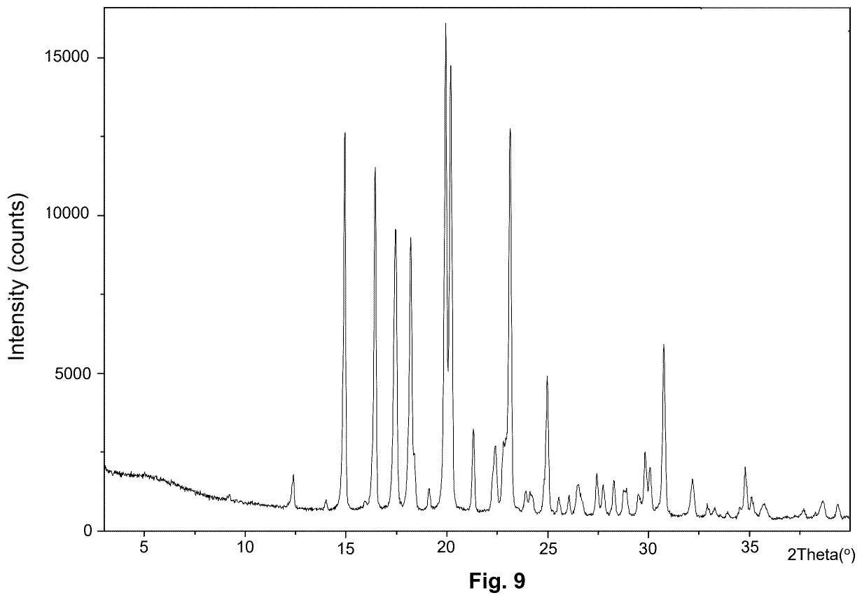

Crystal form X has an XRPD pattern as in FIG. 9.

In one particular embodiment, the ratio A:B of diastereomers A and B in crystal form 1a with a solubility of 0.7±0.07 mg/ml is 97:3.

For comparison, it is worth noting that the registered water solubility value of sulfoxaflor is 568 mg/L in 20° C. (Lewis, K. A., Tzilivakis, J., Warner, D. and Green, A. (2016) An international database for pesticide risk assessments and management. Human and Ecological Risk Assessment: An International Journal 22(4), 1050-1064. DOI: 10.1080/10807039.2015.1133242), which is equivalent to ˜0.57 mg/ml. That is, all the forms of sulfoxaflor in the present invention prove to be advantageously more water soluble than sulfoxaflor in currently known formulations.

### Crystallization of Pure Diastereomers A

In another embodiment, straight-forward crystallization procedures to isolate pure diastereomers A with 90% content, preferably 94%, more preferably 98% and even more preferably 99%±1% of the total content of pure diastereomers A from a mixture of diasteromers A and B are disclosed. These procedures avoid preparation of a complex formulation combined with storage at elevated temperature for a long period of time as described in Table 3 in U.S. Pat. No. 9,125,412. Pure diastereomers A isolated from this crystallization is crystallized in crystal form 1a. These procedures include crash-cooling crystallizations and solvent/antisolvent crystallizations.

The following describes procedures for the preparation of the different crystal forms of X, Y and pure diastereomers A of sulfoxaflor of the present invention, the characteristics of which are detailed above and in the Figures.

### Procedures

### Starting Material

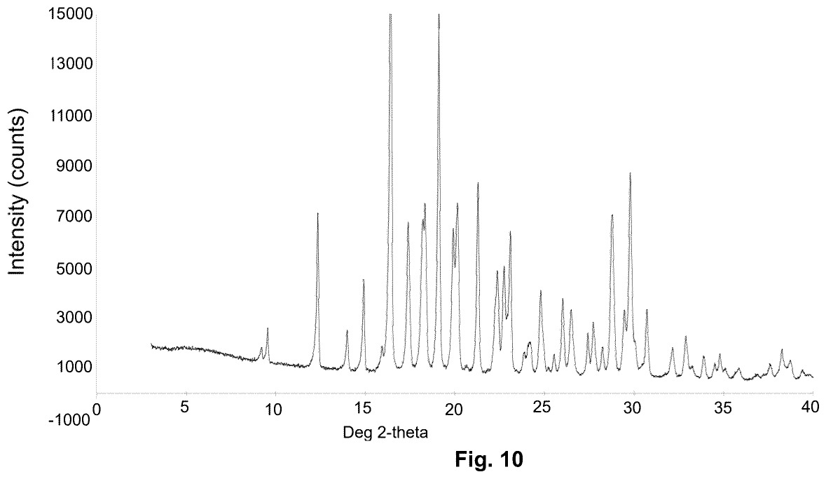

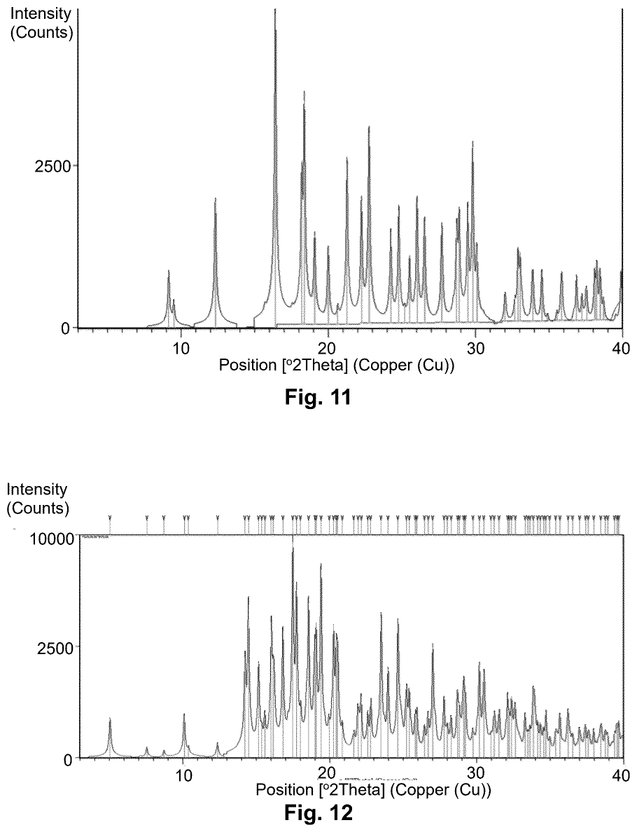

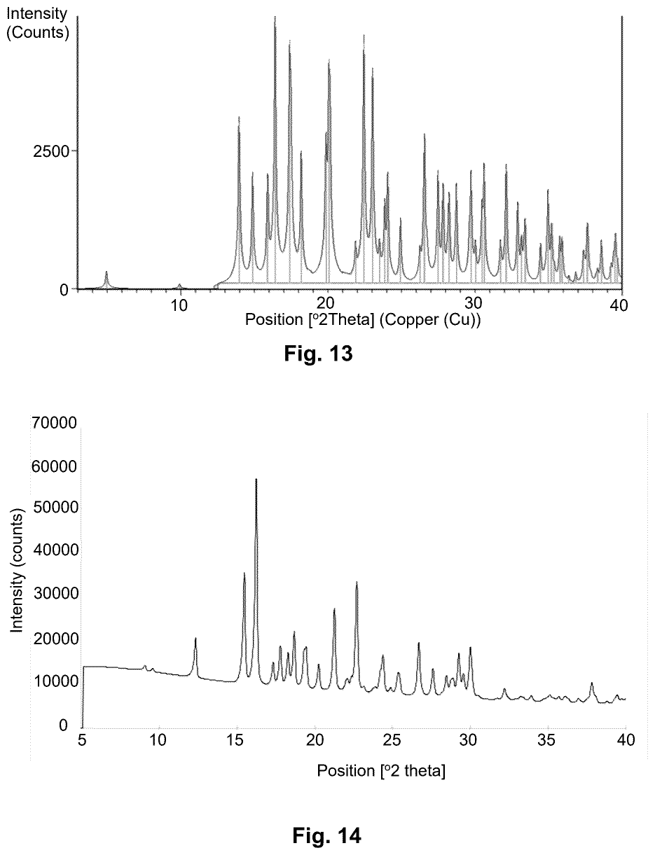

Sulfoxaflor starting material was synthesized according to WO 2008/057129 by oxidation of sulfanylidenecyanamide with m-CPBA and it had a diastereomers ratio A:B 61:37. The XRPD pattern points to a mixture of crystal forms 1a and 1b, see FIG. 10. See also the XRPD patterns of the isolated isomers of sulfoxaflor in FIGS. 11-13 as detailed above.

### Preparation of Crystal Form Y

### Example 1—Preparation of Crystal Form Y

300 mg of sulfoxaflor were dissolved in 7 mL of chloroform by heating up to 80° C. and stirring at 400 rpm. Obtained solution was rapidly cooled using an ice bath (0-5° C.). Crystallization was observed after 10 minutes. The solid material was isolated from the suspension by vacuum filtration. The obtained diastereomers A:B ratio was 91:9. The DSC peak temperature maxima were at 108° C. (small peak) and 148° C.

### Example 2—Preparation of Crystal Form Y

300 mg of sulfoxaflor were dissolved in 30 mL of toluene by heating up to 110° C. and stirring at 400 rpm. Obtained solution was rapidly cooled using an ice bath (0-5° C.). Crystallization was observed after 10 minutes. The suspension was filtered by vacuum filtration. The obtained diastereomers A:B ratio was 88:12. The DSC peak temperature maxima were at 111° C. (small peak) and 154° C.

### Example 3—Preparation of Crystal Form Y

500 mg of sulfoxaflor were dissolved in 20 mL of chloroform (25 mL round bottom flask) by heating up to 80° C. and stirring at 400 rpm. The obtained solution was rapidly cooled using an ice bath (0-5° C.). Crystallization was observed after 5 minutes. The suspension was filtered by vacuum filtration. The obtained diastereomers A:B ratio was 96:4. The DSC peak temperature maximum was at 150° C.

### Example 4—Preparation of Crystal Form Y

500 mg of Sulfoxaflor were dissolved in 5 mL of dichloroethane (in a 25 mL round bottom flask) by heating up to 80° C. and stirring at 400 rpm. The obtained solution was rapidly cooled using an ice bath (0-5° C.). Crystallization was observed after 5 minutes. The suspension was filtered by vacuum filtration. The obtained diastereomers A:B ratio was 93:7. The DSC peak temperature maxima were at 110° C. (small peak) and 149° C.

### Example 5—Preparation of Crystal Form Y

300 mg of Sulfoxaflor were dissolved in 3 mL of dicholorethane by heating up to 80° C. and stirring at 400 rpm. The obtained solution was rapidly cooled using an ice bath (0-5° C.). Crystallization was observed after 5 minutes. The suspension was filtered by vacuum filtration. The obtained diastereomers A:B ratio was 90:10. The DSC peak temperature maxima were at 111° C. (small peak) and 150° C.

### Example 6—Preparation of Crystal Form Y

300 mg of sulfoxaflor were dissolved in 5 mL of ethanol 96% by heating at ˜60° C. and stirring at 400 rpm. The heating was stopped. Then 10 mL of cooled heptane (in an ice bath) was added portion-wisely into the heated solution. Crystallization was observed during the addition of the anti-solvent, and then isolated by vacuum filtration. The obtained diastereomers A:B ratio was at 95:5. The DSC peak temperature maxima were 112° C. (small peak) and 158° C.

### Example 7—Preparation of Crystal Form Y

300 mg of sulfoxaflor were dissolved in 3 mL EtOH 96% by heating up to the boiling point and stirring at a stirring rate of 400 rpm. The heating was stopped. Into an obtained solution 6 mL of cooled (in an ice bath) i-propanol was added portion-wisely. Material started crystallizing immediately after i-propanol addition. The solution was then stirred for 10 minutes and isolated by vacuum filtration. The obtained diastereomers A:B ratio was 96:4. The DSC peak temperature maximum was at 159° C.

### Example 8—Preparation of Crystal Form Y

506 mg of sulfoxaflor were dissolved in 8 mL EtOH 96% by heating up to 60° C. and stirring at a stirring rate of 400 rpm. The heating was stopped. Into the obtained solution 16 mL of cooled (in an ice bath) heptane was added drop-wisely for 30 minutes. The material started crystallizing after ˜5 mL of added heptane. 2 mL of the obtained suspension were filtered 5 min after crystallization started. The suspension was filtered after 3 h of stirring at RT (400 rpm). The obtained diastereomers A:B ratio was 93:7. The DSC peak temperature was at 159° C.

### Example 9—Preparation of Crystal Form Y

300 mg of sulfoxaflor were dissolved in 3 mL ethyl acetate by heating up to 60° C. and stirring at a stirring rate of 400 rpm. The heating was stopped. Into the obtained solution 3 mL of cooled (in an ice bath) heptane was added portion-wisely. The material started crystallizing immediately after heptane addition. The solution was then stirred for 10 minutes and isolated by vacuum filtration. The obtained diastereomers A:B ratio was 92:8. The DSC peak temperature maxima were at 112° C. (small peak) and 153° C.

### Example 10—Preparation of Crystal Form Y

300 mg of sulfoxaflor were dissolved in 3 mL of ethanol 96% by heating at ˜67° C. and stirring (400 rpm). The heating was stopped. Then 12 mL of cooled tert-butyl methyl ether (in an ice bath) was added portion-wisely into the heated solution. Crystallization was observed 10 min after addition of the anti-solvent, then isolated by vacuum filtration. The obtained diastereomers A:B ratio was 93:7. The DSC peak temperature maximum was 160° C.

### Example 11—Preparation of Crystal Form Y

300 mg of sulfoxaflor were dissolved in 3 mL n-butyl acetate by heating up to ˜90° C. and stirring at a stirring rate of 400 rpm. The heating was stopped. Into the obtained solution 12 mL of cooled (in an ice bath) i-propanol was added portion-wisely. No crystallization observed by stirring at RT for 15 minutes. The solution was then cooled using an ice bath. Crystallization was observed within 5 min of stirring. The solution was stirred for 10 minutes and then isolated by vacuum filtration. The obtained diastereomers A:B ratio was 93:7. The DSC peak temperature maximum was 158° C.

### Preparation of Crystal Form X

### Example 12—Preparation of Crystal Form X

300 mg of sulfoxaflor were weighed in a 10 mL glass vial and 3 mL of dichloromethane were added portion-wisely per 0.5 mL every 15 minutes by mixing in a shaker at RT and 400 rpm. The material was partially dissolved. The obtained suspension was maintained by mixing in a shaker at RT and 400 rpm. The suspension was filtered by vacuum filtration, the solid material was disposed, and the mother liquor maintained evaporated slowly. Crystallization was observed within 1 day. The new solid material was filtered by vacuum filtration. The obtained diastereomers A:B ratio was 26:72. The DSC peak temperature maximum was 117° C.

### Example 13—Preparation of Crystal Form X

To 300 mg of sulfoxaflor, 30 mL of t-Butyl Methyl Ether were added portion-wisely by heating up to 80° C. for 15 min and stirring at 400 rpm. The material was not completely dissolved. The suspension was filtered by vacuum filtration and the solid material was disposed. The maintained mother liquor evaporated slowly at RT. Crystallization was observed and the new solid material was isolated by vacuum filtration after 6 days. The obtained diastereomers A:B ratio was 25:75. The DSC peak temperature maximum was 116° C.

### Example 14—Preparation of Crystal Form X

300 mg of sulfoxaflor were dissolved in 9 mL of dichloromethane by heating at ˜50° C. and stirring at 400 rpm. The heating was stopped. Then 9 mL of cooled heptane (in an ice bath) was added portion-wisely into the heated solution. Crystallization was observed during the addition of the anti-solvent, and the solid material was filtered by vacuum filtration and disposed. The mother liquor was maintained at RT. The new solid material was crystallized within 24 h and was isolated by vacuum filtration. The obtained diastereomers A:B ratio was 32:68. The DSC peak temperature maximum was 115° C.

### Example 15—Preparation of Crystal Form X

300 mg of sulfoxaflor were dissolved in 3 mL of ethanol 96% by heating at ˜67° C. and stirring at 400 rpm. The heating was stopped. Then 6 mL of cooled water (in an ice bath) were added portion-wisely into the heated solution. Crystallization was observed during addition of the anti-solvent. The solid material was isolated by vacuum filtration and disposed. The mother liquor was maintained at RT in a closed vial and crystallized within 2 h. The new solid material was filtered by vacuum filtration. The obtained diastereomers A:B ratio was 28:71. The DSC peak temperature was maximum at 114° C.

### Example 16—Preparation of Crystal Form X

Mother liquor after filtration of a sample prepared according to example 4 was maintained letting the liquor to evaporate slowly. The solid material was crystallized within 2 weeks and then was filtered by vacuum filtration. The obtained diastereomers A:B ratio was 31:67. The DSC peak temperature was maximum at 119° C.

### Example 17—Preparation of Crystal Form X

Material from the mother liquor of Example 9 was crystallized during filtration. The solid material was filtered. The obtained diastereomers A:B ratio was 19:81. The DSC peak temperature maximum was 115° C.

### Example 18—Preparation of Crystal Form X

300 mg of Sulfoxaflor were dissolved in 3 mL of i-propyl acetate by heating up to 100° C. and stirring for 400 rpm. The obtained solution was rapidly cooled using an ice bath (0-5° C.). Crystallization was observed after 5 minutes. The suspension was further filtered by vacuum filtration and the solid material was disposed. The mother liquor maintained evaporated slowly. Crystallization was observed within 5 days, then the new solid material was isolated by vacuum filtration. The obtained diastereomers A:B ratio was 31:69.

### Preparation of Pure Diastereomers A

### Example 19—Preparation of Pure Diastereomers A—Crash-Cooling in Methanol

300 mg of sulfoxaflor were dissolved in 3 mL of methanol by heating up to 70° C. and stirring for 400 rpm. The obtained solution was rapidly cooled using an ice bath (0-5° C.). Crystallization was observed after 15 minutes. The suspension was filtered by vacuum filtration. The obtained diastereomers A:B ratio was 92:8.

### Example 20—Preparation of Pure Diastereomers A—Crash-Cooling in Ethylacetate

300 mg of sulfoxaflor were dissolved in 3 mL of ethyl acetate by heating up to 70° C. and stirring for 400 rpm. The obtained solution was rapidly cooled using an ice bath (0-5° C.). Crystallization was observed after 5 minutes. The suspension was filtered by vacuum filtration. The obtained diastereomers A:B ratio was 89:10.

### Example 21—Preparation of Pure Diastereomers A—Crash-Cooling in Methyl Isobutyl Ketone

300 mg of sulfoxaflor were dissolved in 3 mL of methyl isobutyl ketone by heating up to 70° C. and stirring for 400 rpm. The obtained solution was rapidly cooled using an ice bath (0-5° C.). Crystallization was observed after 10 minutes, then the solid material was isolated by vacuum filtration. The obtained diastereomers A:B ratio was 87:13.

### Example 22—Preparation of Pure Diastereomers A—Acetone/Water

300 mg of sulfoxaflor were dissolved in 3 mL of acetone stirring for 400 rpm at RT. Then 6 mL of water were added portion-wisely. Crystallization was observed after 1 min of stirring at RT, then the solid material was isolated by vacuum filtration. The obtained diastereomers A:B ratio was 97:3.

### Example 23—Preparation of Pure Diastereomers A—Acetonitrile/Water

300 mg of sulfoxaflor were dissolved in 3 mL of acetonitrile stirring for 400 rpm at RT. Then 6 mL of water were added portion-wisely. Crystallization was observed after 1 min of stirring at RT, then the solid material was isolated by vacuum filtration. The obtained diastereomers A:B ratio was 99:1.

### Example 24—Preparation of Pure Diastereomers A—Acetone/Tert-Butyl Methyl Ether

500 mg of sulfoxaflor were dissolved in 5 mL of acetone stirring for 400 rpm at RT. Then 20 mL of tert-butyl methyl ether were added portion-wisely. Crystallization was observed after 2 min of stirring at RT, then the solid material was isolated by vacuum filtration. The obtained diastereomers A:B ratio was 98:2.

### Example 25—Preparation of Pure Diastereomers A—Tetrahydrofuran/Water

300 mg of sulfoxaflor were dissolved in 3 mL of tetrahydrofuran by heating at ˜70° C. and stirring (400 rpm). Heating was stopped. Then 9 mL of cooled water (in an ice bath) was added portion-wisely into the heated solution. Crystallization was observed during addition of the anti-solvent, then the solid material was isolated by vacuum filtration. The obtained diastereomers A:B ratio was 96:4.

### Example 26—Preparation of Pure Diastereomers A—Ethanol 96%/I-Propanol

300 mg of sulfoxaflor were dissolved in 3 mL EtOH 96% by heating up to the boiling point and stirring at a stirring rate of 400 rpm. Heating was stopped. Into the obtained solution, 6 mL of cooled (in an ice bath) i-propanol was added portion-wisely. The material started crystallizing immediately after i-propanol addition, then stirred for 10 minutes and isolated by vacuum filtration. The obtained diastereomers A:B ratio was 95:5.

### Example 27—Preparation of Pure Diastereomers A—Methanol/Water

300 mg of sulfoxaflor were dissolved in 3 mL MeOH by heating up to the boiling point and stirring at a stirring rate of 400 rpm. Heating was stopped. Into the obtained solution, 3 mL of cooled (in an ice bath) water was added portion-wisely. The material started crystallizing immediately after addition of water, then stirred for 10 minutes and isolated by vacuum filtration. The obtained diastereomers A:B ratio was 95:5.

### Example 28—Preparation of Pure Diastereomers A—Ethanol 96%/Heptane

506 mg of sulfoxaflor were dissolved in 8 mL EtOH 96% by heating up to 60° C. and stirring at a stirring rate of 400 rpm. The heating was stopped. Into the obtained solution 16 mL of cooled (ice bath) heptane were added drop-wisely for 30 minutes. The material started crystallizing after ˜5 mL of added heptane. 2 mL of obtained suspension were filtered 5 min after crystallization started (Product 1). 4 mL of suspension were filtered after 3 h of stirring at RT (400 rpm) (Product 2). The obtained Products 1 and 2 had diastereomers A:B ratio respectively 94:6 and 95:5.

### Example 29—Preparation of Pure Diastereomers A—Ethylacetate/I-Propanol

300 mg of sulfoxaflor was dissolved into 3 mL ethyl acetate by heating up to 60° C. and stirring at a stirring rate of 400 rpm. Heating was stopped. Into the obtained solution, 12 mL of cooled (in an ice bath) i-propanol was added portion-wisely. No crystallization was observed after 1 h of stirring. The solution was then cooled using an ice bath. Crystallization was observed within 5 min of stirring, then stirred for 10 minutes and material was isolated by vacuum filtration. The obtained diastereomers A:B ratio was 93:7.

### Example 30—Preparation of Pure Diastereomers A—Acetone/Tert-Butyl Methyl Ether

3000 mg of sulfoxaflor were dissolved in 30 mL of acetone, stirring at 400 rpm at room temperature (RT). Then 120 mL of tert-butyl methyl ether were added portion-wisely. Crystallization was observed after 2 min of stirring at room temperature and the stirring was maintained for 10 minutes. The material was isolated by vacuum filtration. The obtained diastereomers A:B ratio was 92:8.

### Example 31—Preparation of Pure Diastereomers A—Acetonitrile/Water

3000 mg of sulfoxaflor were dissolved in 30 mL of acetonitrile by stirring at RT and at a stirring rate of 400 rpm. Into the obtained solution, 60 mL of water was added portion-wisely by stirring at RT. Crystallization was observed during addition of the antisolvent, then the solid material was isolated by vacuum filtration. The obtained diastereomers A:B ratio was 96:4.

It is worth noting that the methods for preparing pure diastereomers A as exemplified in detail above effectively enable to obtain a stable product in a faster and easier way relative to what is currently known in the prior art. This aspect of the invention is particularly highlighted compared for example with the slow, heat and time-consuming method of conversion of diastereomers B to diastereomers A, which is taught in U.S. Pat. No. 9,125,412 (see Col. 31-32 therein). Therefore, in one embodiment, the present invention pertains to a stable pure diastereomers A product, which is produced by the methods of present invention as detailed and exemplified.

Tables II-IV below summarize the solvents which were used in the production of crystal forms Y, X and pure diastereomers A at the different stages of the procedures detailed above.

TABLE II
Summary of solvents for crystal form Y

| | | Solvent/antisolvent | |
|---|---|---|---|
| | crash-cooling | 1^{st} solvent | 2^{nd} solvent |
| Preparation of | Chloroform | | |
| crystal form Y | toluene | | |
| | dichloroethane | Ethanol 96% | tert-butyl |
| | | | methyl ether |
| | | Ethanol 96% | heptane |
| | | Ethanol 96% | i-propanol |
| | | ethylacetate | heptane |
| | | n-butyl acetate | i-propanol |

TABLE III
Summary of solvents for crystal form X

| | Mother liquor evaporation |
|---|---|
| Preparation of crystal | Dichloromethane/heptane |
| form X | t-Butyl Methyl ether |
| | Ethanol 96% / water |
| | Dichloroethane |
| | ethyl acetate/heptane |
| | i-propyl acetate |

TABLE IV
Summary of solvents for pure diastereomers A

| | | Solvent/antisolvent | |
|---|---|---|---|
| | crash-cooling | 1^{st} solvent | 2^{nd} solvent |
| Preparation of pure | methanol | | |
| diastereomers A | ethyl acetate | | |
| | Methyl isobutyl | | |
| | ketone | | |
| | | acetone | water |
| | | acetonitrile | water |
| | | acetone | Tert-butyl methyl |
| | | | ether |
| | | tetrahydrofuran | water |
| | | Ethanol 96% | i-propanol |
| | | methanol | water |
| | | Ethanol 96% | heptane |
| | | ethyl acetate | i-propanol |

### Experimental

1. XRPD: The XRPD patterns were recorded at room temperature using copper Kα radiation on a PANalytical X'Pert Pro powder diffractometer model PW3040/60 in Bragg-Brentano geometry equipped with a X'celerator detector. The samples were prepared by mounting ˜35 mg of the (gently grinded) sample on a PW1818/32 Zero Background Holder with cavity and scanned from 3 to 40°2θ using the following acquisition parameters: generator tension 45 kV, generator current 40 mA step size 0.0167°, scan speed 0.05°/second, number of steps 2214 and total time 12 min.
2. DSC: DSC data were collected on Mettler Toledo DSC 822^{e} calorimeter equipped with a refrigerated cooling system. Samples (about 3-4 mg) were placed into aluminum DSC pans covered with a pinhole punched lid. The sample cell was heated at a rate of 10° C./min over the temperature range of 25 to 200° C. A nitrogen purge of 50 ml/min was maintained over the sample.

1. A combination of stereoisomers of sulfoxaflor,
wherein said stereoisomers are selected from diastereomers A and B,
wherein said diastereomers A and B are provided as mixed crystals at a selected A:B ratio, and
wherein said composition is water soluble with water solubility of at least about 0.70±0.07 mg/ml.

2. The combination according to claim 1, wherein said diastereomers A comprises a racemic mixture of R,R and S,S enantiomers of said sulfoxaflor,
wherein said mixed crystal is form Y that comprises crystal forms 1a and a novel crystal phase,
wherein said mixed crystal form 1a and novel crystal phase of said form Y crystallize at a ratio that produces a constant XRPD pattern.

3. The combination according to claim 2, wherein said content of said crystal structures of said diastereomers A is 90%, preferably 92%, more preferably 94%, and even more preferably 96%±1% of said total content of said form Y.

4. The combination according to claim 2, wherein a DSC thermogram of said form Y displays a melting peak with a peak maximum temperature in the range of 140-160° C.

5. The combination according to claim 2, wherein said form Y is characterized by XRPD peaks at 15.5, 16.3, 17.4, 19.2, 26.0±0.2 deg 2 theta.

6. The combination according to claim 5, wherein said form Y is further characterized by XRPD peaks at 19.4, 20.0, 21.3, 22.7±0.2 deg theta.

7. The combination according to claim 2, wherein said water solubility of said composition is about 1.2±0.3 mg/ml.

8. The combination according to claim 1, wherein said ratio A:B is between 3:7 and 2:8,
wherein said mixed crystal of said diastereomers A and B is form X comprising crystal form 1a and crystal form 1b.

9. The combination according to claim 8, wherein said diastereomers B is a racemic mixture of R,S and S,R enantiomers of said sulfoxaflor,
wherein content of said diastereomers B is between 60% and 80%, preferably between 65% and 75% and more preferably 70% of total content of said composition.

10. The combination according to claim 8, wherein a DSC thermogram of said form X is characterized by one melting peak with a peak temperature maximum at about 114-119° C.

11. The combination according to claim 9, wherein said water solubility of said composition is about 1.6±0.3 mg/ml.

12. A combination comprising pure diastereomers A with at least 90%, preferably 94%, more preferably 96%, even more preferably 98% and even more preferably 99%±1% of said diastereomers A.

13. A method for preparing mixed crystal forms selected from Y, X and pure diastereomers A of sulfoxaflor, said method is selected from crash-cooling, solvent-anti-solvent, mother liquor evaporation and crystallization during filtration methods for crystallizing said forms of sulfoxaflor.

14. The method according to claim 13, wherein said method is a crash-cooling method comprising:
dissolving a starting material of said sulfoxaflor in a solvent;
heating and stirring a solution of said sulfoxaflor;
rapidly cooling said solution in an ice bath with a temperature between 0 and 5° C.; and
letting said solution of said sulfoxaflor make a suspension; and
isolating a solid material from said suspension.

15. The method according to claim 14, wherein said method is for preparing said form Y,
wherein said solvent is selected from chloroform, toluene and dichloroethane.

16. The method according to claim 14, wherein said method is for preparing said form X,
wherein said solvent is i-propyl acetate, and wherein said method further comprises:
filtering said suspension;
evaporating of a mother liquor and obtaining a new suspension; and
isolating a solid material from said suspension.

17. The method according to claim 16, wherein said isolating of said solid material is selected from filtering, sedimentation and decantation, evaporation and centrifugation.

18. The method according to claim 14, wherein said method is for preparing said pure diastereomers A at a content of 90%, preferably 94%, more preferably 96%, even more preferably 98% and even more preferably 99%±1% of total content of sulfoxaflor, wherein said solvent is selected from methanol, ethyl acetate and methyl isobutyl ketone.

19. The method according to claim 13, wherein said method is a solvent-anti-solvent method comprising:
dissolving a starting material of said sulfoxaflor in a solvent by heating and stirring to a solution comprising said starting material of said sulfoxaflor;
drop-wisely adding an anti-solvent, said anti-solvent is cooled in an ice bath; and
stirring said anti-solvent in said solution until crystallization of a solid material.

20. The method according to claim 19, wherein said drop-wisely adding said anti-solvent is done after cooling said suspension.

21. The method according to claim 20, further comprising isolating said crystal form from said suspension.

22. The method according to claim 21, wherein said isolating said crystal form from said suspension is selected from filtering said crystal form, sedimentation and decantation, evaporation and centrifugation.

23. The method according to claim 13, wherein said method is mother liquor evaporation for preparing form X, wherein solvent/anti-solvent pairs or a single solvent are used to form said mother liquor from which said form X crystallizes, solvent/anti-solvent pairs are selected from dichloromethane/heptane and ethanol 96%/water, said solvent is selected from t-butyl methyl ether, dichloroethane and i-propyl acetate.

24. The method according to claim 23, wherein said method of mother liquor evaporation comprises:
dissolving a starting material of sulfoxaflor in a solvent;
heating and stirring a solution of said sulfoxaflor;
cooling said solution;
drop-wisely adding an anti-solvent to said solution after cooling, wherein said anti-solvent is cooled in an ice bath;
stirring said anti-solvent to said solution until a suspension is formed; and
disposing a solid material in said suspension;
evaporating said mother liquor and crystallizing a new solid material in a suspension; and
isolating said new solid material from said suspension.

25. The method according to claim 23, wherein said method of mother liquor evaporation comprises:
crash-cooling of said sulfoxaflor solution;
stirring until a suspension is formed; and
disposing a solid material in said suspension.

26. The method according to claim 19, wherein said method is for preparing said pure diastereomers A at a content of 90%, preferably 94%, more preferably 96%, even more preferably 98% and even more preferably 99%±1%, wherein said solvent is selected from acetone, acetonitrile, tetrahydrofuran, ethanol 96%, methanol and ethyl acetate, said anti-solvent is selected from water, tert-butyl methyl ether, water, i-propanol and heptane.

27. The method of claim 26, wherein said pure diastereomers A crystallize in crystal form 1a.

28. A composition comprising pure diastereomers A with at least 90%, preferably 94%, more preferably 96%, even more preferably 98% and even more preferably 99%±1% of said diastereomer A, said composition is produced by the method according to claim 14.

29. A crystal phase Yn characterized by a XRPD pattern primarily by peaks at 15.5, 16.3, 17.4, 19.4, 21.3, 22.7±0.2 deg 2-theta.

30. An insecticide and/or pesticide preparation comprising mixtures of crystal mixtures of forms selected from X, Y and pure diastereomers A of sulfoxaflor alone or in addition to or in combination with other insecticide and pesticide compounds.
